(19) United States
(12) Patent Application Publication
(10) Pub. No.: US 2007/0002002 A1
(43) Pub. Date: Jan. 4, 2007

(54) Pushing assembly for data storage device

(75) Inventors: Xiao-Gang Jiang, Shenzhen (CN); Qi-Fei Fan, Shenzhen (CN); Hung-Chun Lu, Tu-Cheng (TW); Wen-Kang Lo, Tu-Cheng (TW); Chien-Li Tsai, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/452,536

(22) Filed: Jun. 14, 2006

(30) Foreign Application Priority Data
Jun. 17, 2005 (CN) 200520060180.9

(51) Int. Cl. G09G 3/36

(52) U.S. Cl. 345/102; 360/294.7; 361/683; 345/685

(57) ABSTRACT

A pushing assembly is provided for pushing a data storage device out of a computer enclosure. The pushing assembly includes an installing portion, a pushing member and an operation portion. The installing portion is arranged in the computer enclosure. The pushing member is disposed in the installing portion. The operation portion is attached to the pushing member. The operation portion drives the pushing member to slide along the installing portion and the pushing member pushes the data storage device to slide a certain distance to facilitate the data storage device being taken out from the computer enclosure.

### BACKGROUND OF THE INVENTION

1. Field of the Invention

The present invention relates to pushing assembly for data storage devices, and particularly to a pushing assembly for readily pushing a data storage device out of a computer enclosure.

2. General Background

The production of notebook computer has become mature and entered a meager profit era. Only cost down and bringing convenience to users can bring more competitive strength. Typically, data storage devices, such as hard disk drives (HDDs), and compact disk-read only memory (CD-ROM) drives, are attached to a bottom panel of a notebook computer enclosure. A connecter of a data storage device connects with a connecter of a motherboard in the notebook computer to exchange data. However, because the interior space of the notebook computer enclosure is very limited, some elements besides the data storage device must be detached in order to achieve operating space for pulling out the connecter of the data storage devices from the connecter of the motherboard. The process of detaching a data storage device is very inconvenient.

What is needed is a pushing assembly for readily pushing a data storage device out of a computer enclosure.

### SUMMARY

In one preferred embodiment, a pushing assembly is provided for pushing a data storage device out of a computer enclosure. The pushing assembly includes an installing portion, a pushing member and an operation portion. The installing portion is arranged in the computer enclosure. The pushing member is disposed in the installing portion. The operation portion is attached to the pushing member. The operation portion drives the pushing member to slide along the installing portion and the pushing member pushes the data storage device to slide a certain distance to facilitate the data storage device being taken out from the computer enclosure.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a pushing assembly in accordance with a preferred embodiment of the present invention, together with a data storage device, a mounting apparatus and a notebook computer enclosure;

FIG. 2 is an assembled view of the pushing assembly and the notebook computer enclosure;

FIG. 3 is an assembled view of FIG. 1, showing the data storage device being locked;

FIG. 4 is an inverted view of FIG. 3; and

FIG. 5 is an assembled view of FIG. 1, showing the data storage device being pushed out.

### DETAILED DESCRIPTION OF THE EMBODIMENTS

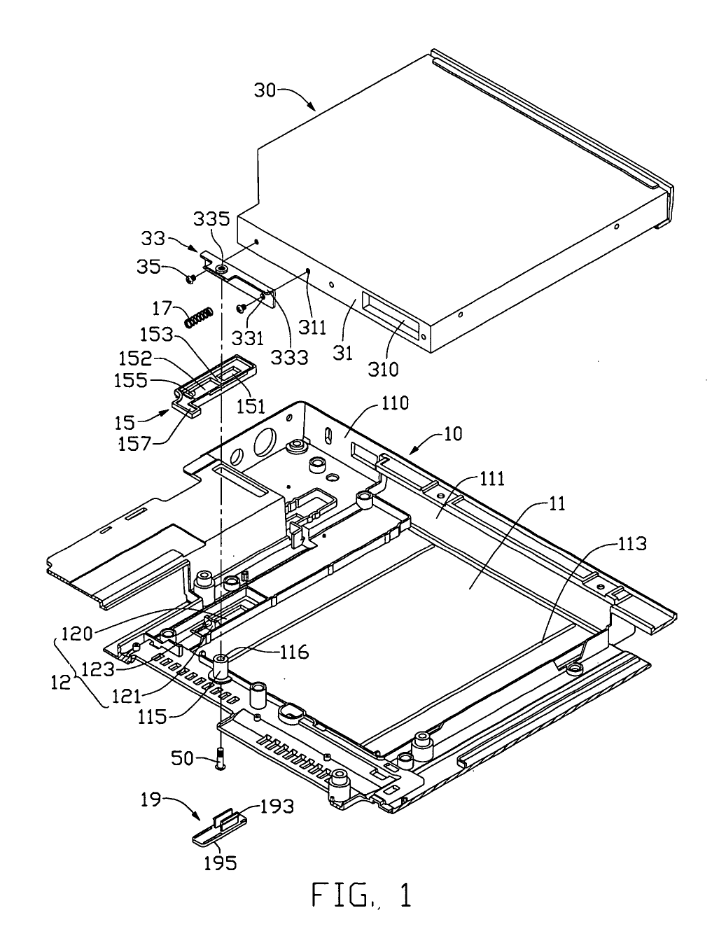

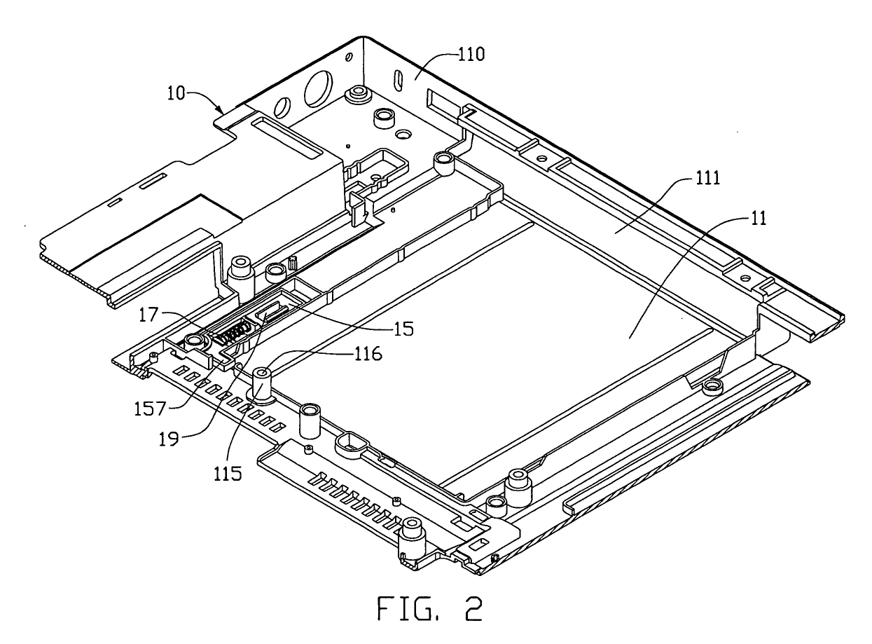

Referring to FIGS. 1 and 2, a pushing assembly in accordance with a preferred embodiment of the present invention is provided to push an electronic component out of an enclosure 10 of an electronic device like a notebook computer. The component is a data storage device 30 in this preferred embodiment. The notebook computer enclosure 10 includes a bottom panel 11 and a side panel 110. An opening 111 is defined in the side panel 110 for entry of the data storage device 30. A plurality of sliding rails 113 is formed on the bottom panel 11 to reduce friction when the data storage device slides into or out of the notebook computer enclosure 10. A rear wall 31 of the data storage device 30 includes a connecter 310.

The data storage device 30 is attached to the notebook computer enclosure 10 by a mounting apparatus. The mounting apparatus includes a positioning post 115, a fixing plate 33 and a screw 50. The positioning post 115 protrudes from the bottom panel 11, and a round hole 116 is defined in the positioning post 115. A pair of through holes 331 is defined in the body of the fixing plate 33. A pair of threaded holes 311 is defined in the rear wall 31 of the data storage device 30. A pair of screws 35 extends through the through holes 331 then engages in the threaded holes 311 respectively, thus the fixing plate 33 is mounted to the rear wall 31 of the data storage device 30. The fixing plate 33 includes a bent portion 333 with a securing hole 335. The screw 50 extends through the round hole 116 of the positioning post 115 then engages in the securing hole 335 of the fixing plate 33, thus the data storage device 30 is attached to the notebook computer enclosure 10.

The pushing assembly includes an installing portion 12, a pushing member 15, a resilient element 17, and an operation portion 19.

The installing portion 12 is integrally formed on a inner side of the bottom panel 11 of the notebook computer enclosure 10. The installing portion 12 includes a sliding slot 120 and a stopper tab 121. The sliding slot 120 is defined in the bottom panel 11. The stopper tab 121 protrudes from an end of the sliding slot 120 to the internal space of the notebook computer enclosure 10. A first protruding post 123 protrudes from the stopper tab 121 and extends parallel with the bottom panel 11.

The pushing member 15 is L-shaped. A locking hole 151 and a sliding groove 152 are defined in the body of the pushing member 15. A rib 153 is formed between the locking hole 151 and the sliding groove 152 to separate them form each other. A second protruding post 155 is formed on a rear edge of the sliding groove 152 corresponding to the first protruding post 123. The pushing member 15 includes a pushing portion 157 extending from its rear portion vertically.

The resilient element 17 is a coil spring in this preferred embodiment.

The operation portion 19 includes a pair of clasps 193 and a manipulating section 195. The manipulating section 195 forms a plurality of ridges on a back surface thereof for facilitating manual operation. The clasps 193 extend from an inner surface of the manipulating section 195.

In assembling the pushing assembly, the clasps 193 extend through the sliding slot 120 and the locking hole 151, and engage with the edges of the locking hole 151. Thus, the operating portion 19 is arranged in an outer side of the bottom panel 11, and the pushing member 15 can slide with the operating portion 19 along the sliding slot 120. The stopper tab 121 extends through the sliding groove 152. The two ends of the resilient element 17 receive the first protruding post 123 and the second protruding post 155 respectively, thus the resilient element 17 is disposed between the stopper tab 121 and the rear edge of the sliding groove 152. The resilient element 17 pushes the pushing member 15 away from the side panel 110 of the notebook computer enclosure 10.

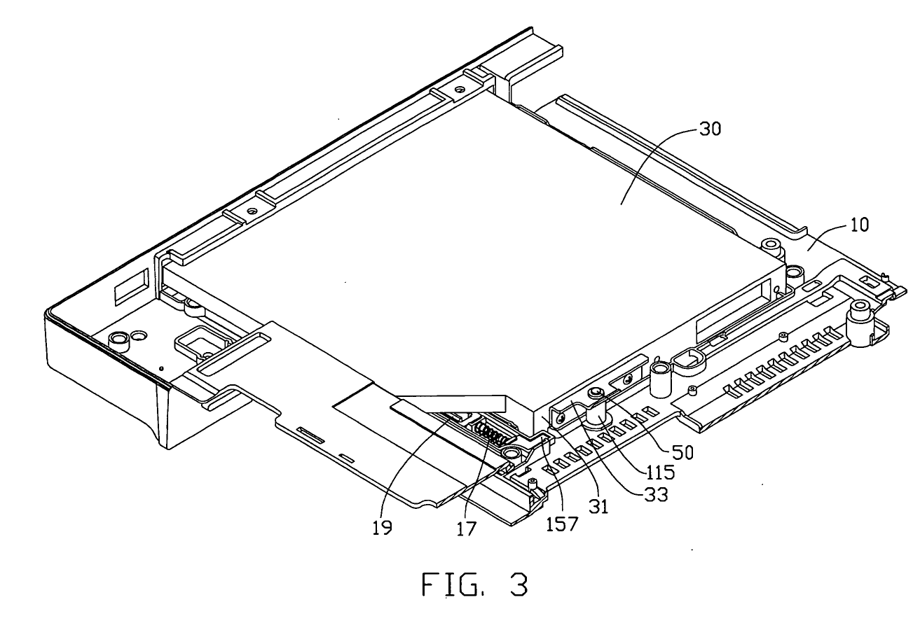

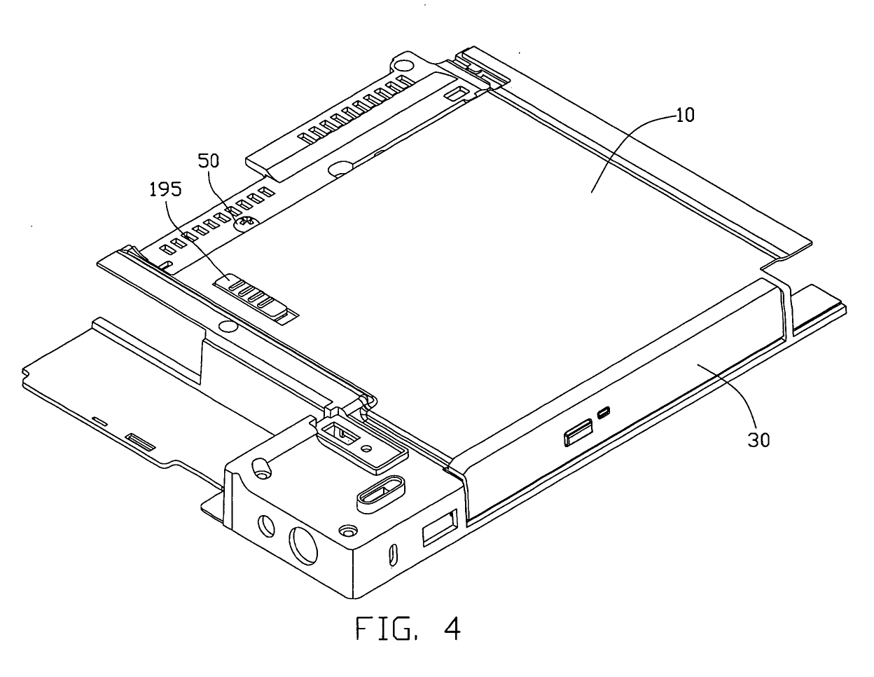

Referring also to FIGS. 3 and 4, in assembling the data storage device 30, the fixing plate 33 is mounted to the rear wall 31 of the data storage device 30 by the screws 35. The data storage device 30 is pushed into the notebook computer enclosure 10 from the opening 111. The connecter 310 connects with a connecter of a motherboard in the notebook computer enclosure 10. The screw 50 extends through the round hole 116 of the positioning post 115 then engages in the securing hole 335 of the fixing plate 33, thus the data storage device 30 is attached to the notebook computer enclosure 10. The pushing portion 157 of the pushing member 15 abuts against the rear wall 31 of the data storage device 30.

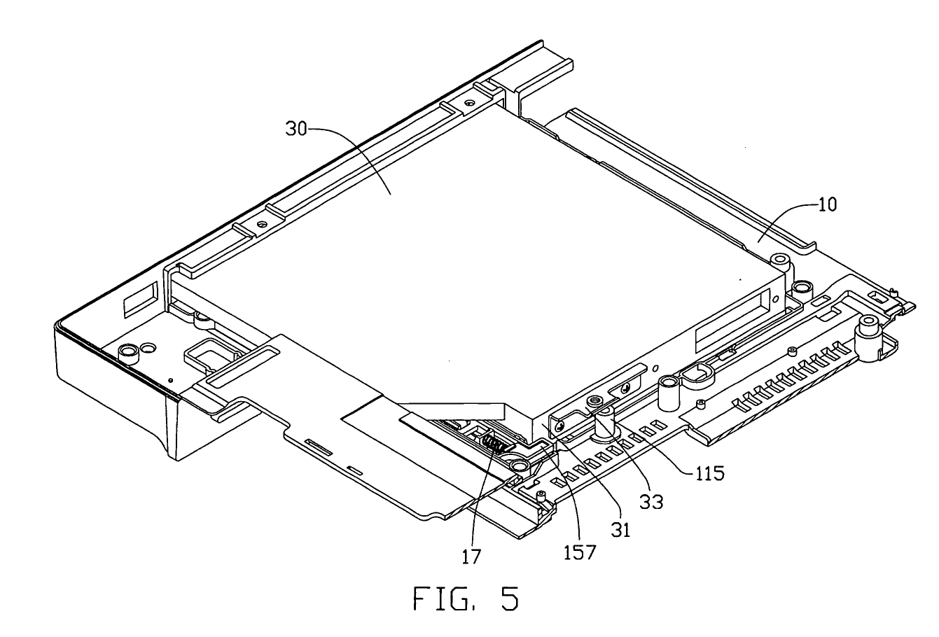

Referring also to FIG. 5, in detaching the data storage device 30, the screw 50 is unscrewed from the securing hole 335 of the fixing plate 33. The manipulating section 195 of the operation portion 19 is pushed to slide the operation portion 19, and the pushing member 15 is driven by the operation portion 19 to slide along the sliding slot 120. The resilient element 17 is compressed, and the pushing portion 157 pushes the data storage device 30 sliding forward. Therefore, the connecter 310 is pulled out and the data storage device 30 is pulled out a certain distance to facilitate being taken out from the notebook computer enclosure 10. When the external force exerted on the manipulating section 195 of the operation portion 19 is canceled, the pushing member 15 and the operating portion 19 slide back via the restoring force of the resilient element 17.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

We claim:

1. A pushing assembly for pushing a data storage device out of a computer enclosure, the pushing assembly comprising:
an installing portion arranged in the computer enclosure;
a pushing member movably disposed in the installing portion, the pushing member pushing the data storage device to slide a certain distance to facilitate the data storage device being taken out from the computer enclosure; and
an operation portion attached to the pushing member, and the operation portion driving the pushing member to slide along the installing portion.

2. The pushing assembly as claimed in claim 1, wherein the data storage device comprises a rear wall, and a pushing portion of the pushing member abuts against and pushes the rear wall to slide the data storage device.

3. The pushing assembly as claimed in claim 1, wherein the operation portion comprises a pair of clasps, the installing portion comprises a sliding slot, the pushing member comprises a locking hole, the clasps extend through the sliding slot and the locking hole, and engage with the edges of the locking hole, thus the pushing member slides with the operating portion along the sliding slot.

4. The pushing assembly as claimed in claim 3, further comprising a resilient element, wherein the resilient element is disposed between the installing portion and the pushing member to keep the pushing member at a certain state.

5. The pushing assembly as claimed in claim 4, wherein the installing portion comprises a stopper tab with a first protruding post, the pushing member defines a sliding groove, a second protruding post is formed on a rear edge of the sliding groove corresponding to the first protruding post, the resilient element is a coil spring and its two ends receive the first protruding post and the second protruding post respectively.

6. The pushing assembly as claimed in claim 3, wherein the operation portion comprises a manipulating section, the clasps extend from an inner surface of the manipulating section, and the manipulating section forms a plurality of ridges on a back surface thereof for facilitating manual operation.

7. The pushing assembly as claimed in claim 1, wherein the computer enclosure comprises a bottom panel, the installing member is arranged in the bottom panel.

8. The pushing assembly as claimed in claim 7, wherein a plurality of sliding rails is formed on the bottom panel to reduce friction when the data storage device slides into or out of the computer enclosure.

9. The pushing assembly as claimed in claim 1, wherein the computer enclosure comprises a side panel, an opening is defined in the side panel for entry of the data storage device.

10. A pushing assembly for pushing an electronic component out of an enclosure of an electronic device without opening the enclosure, the pushing assembly comprising:
an installing portion arranged in an inner side of the enclosure;
a pushing member movably disposed in the installing portion, a pushing portion extending from the pushing member, and the pushing portion abutting against and pushing the electronic component sliding a certain distance to facilitate the electronic component being taken out from the enclosure; and
an operation portion attached to the pushing member and arranged in an outer side of the enclosure, and the operation portion driving the pushing member to move along a first direction in which the electronic component moves.

11. The pushing assembly as claimed in claim 10, wherein the pushing portion extends from the pushing member in a second direction perpendicular to the first direction to push a rear wall of the electronic component.

12. The pushing assembly as claimed in claim 10, wherein the operation portion comprises a pair of clasps, the installing portion comprises a sliding slot, the pushing member comprises a locking hole, the clasps extend through the sliding slot and the locking hole, and engage with the edges of the locking hole, thus the pushing member slides with the operating portion along the sliding slot.

13. The pushing assembly as claimed in claim 12, further comprising a resilient element, wherein the resilient element is disposed between the installing portion and the pushing member to keep the pushing member at a certain state.

14. The pushing assembly as claimed in claim 13, wherein the installing portion comprises a stopper tab with a first protruding post, the pushing member defines a sliding groove, a second protruding post is formed on a rear edge of the sliding groove corresponding to the first protruding post, the resilient element is a coil spring and its two ends receive the first protruding post and the second protruding post respectively.

15. The pushing assembly as claimed in claim 10, wherein the electronic component comprises a connecter at a rear wall thereof to connect with the electronic device.

16. An electronic device comprising:
an enclosure of said electronic device enclosing said electronic device, and comprising a side panel extending along a side thereof, said enclosure defining a space therein beside said side panel, and an opening defined at said side panel to spatially communicate said space with an outside of said electronic device;
an electronic component of said electronic device removably installable in said space of said enclosure to function for said electronic device, said electronic component movable through said opening between a first position thereof where said electronic component completely resides in said space to function and is flush with said side panel along said opening, and a second position thereof where a portion of said electronic component is protrusively exposable to said outside of said electronic device to be ready for removal out of said electronic device; and
a pushing member movably installable in said enclosure beside said space, said pushing member operably movable to engage with said electronic component in order to force said electronic component to move from said first position thereof toward said second position thereof for said removal of said electronic component.

17. The electronic device as claimed in claim 16, wherein said pushing member abuts against said electronic component when said electronic component is in said first position thereof to completely reside in said space.

18. The electronic device as claimed in claim 16, further comprising an operation portion attachable to said pushing member to move together therewith, and extending to be exposable to said outside of said electronic device to accept user operation for controlling movement of said pushing member.
